(19) United States
(12) Patent Application Publication
(10) Pub. No.: US 2004/0015519 A1
(43) Pub. Date: Jan. 22, 2004

(54) Content delivery server and content delivery system having the same

(76) Inventor: Yukitoshi Maeda, Nara (JP)

Correspondence Address: PITNEY, HARDIN, KIPP & SZUCH LLP, 685 THIRD AVENUE, NEW YORK, NY, 10017-4024, US

(21) Appl. No.: 10/363,834

(22) PCT Filed: Jul. 25, 2002
(86) PCT No.: PCT/JP02/07563

(30) Foreign Application Priority Data
Oct. 15, 2001 (JP) 2001-316237

(51) Int. Cl. G06F 12/00

(52) U.S. Cl. 707/200

(57) ABSTRACT

The apparatus includes a server for file distribution that can restrict the use of files within a certain limit and file distribution system therewith.

The file distribution server includes a file data memory to store digital file data to distribute, a program memory to store a computer program to manage and play back digital file data, and a transfer-processing unit 26 to transfer the management/playback program, file data and data on a date at which playback can be started and by when it has to be finished. The management/playback program carries out the following steps: playing back files after it is started on the user terminal, reading time data of user terminal and checking if read time is between the date at which playback can be started and when it has to be finished, deleting file data when the read time is not in the period, making it possible to play back when the read time is in the period, and rewriting date at which playback can be started with read time data.

### FIELD OF THE INVENTION

The present invention relates to a server for file distribution and file distribution system therefor. The server and the system are constructed to distribute various files to user computers or terminals, which are connected to a communication network such as the Internet.

### BACKGROUND OF THE INVENTION

In general, musical productions are copied onto various media, such as records, CDs (compact discs), and cassettes, and then they are sold in stores, or rented for a limited period. Movie productions are also copied into media such as videotapes and DVDs (digital video discs), and are sold or rented in stores. In addition, game programs for playing on computers (software games) are recorded in media such as CD-ROMs and sold in stores. Digital novels are also sold in stores as publications.

### DISCLOSURE OF THE INVENTION

However, these measures for selling or renting productions require users to come to stores. If users have little spare time, they may miss the opportunities for purchasing or renting those productions. Therefore, these measures are not necessarily convenient for users.

On the other hand, recently the Internet has proliferated, and transactions using the Internet, such as online transactions, have increased. These online transactions are highly convenient because users need not to go to stores. In this regard, current distribution systems for digital files (music, movies, software games, novels, etc.) are constructed on the Internet as web pages. Users can access the web pages with their computers, and download the digital files.

The digital files, which are the objects of the distribution system, are often copies. Since copyrights of authors are valid for these digital files, further production and renting of the files are basically prohibited without the permission of the authors. Therefore, in those distribution systems, when distributing the digital files, it is necessary to acquire permission of the authors.

However, regardless of whether users are aware of it or not, those distribution systems make copies of the files on the users' computers when the files are distributed, and make it possible for the users to use the copies repeatedly. Therefore, in the case of rental, for which users are supposed to use the files for a limited period, it is necessary to control the rental periods strictly, and to take effective measures against use after the rental periods.

The present-day distribution systems using the Internet mentioned above, however, do not enable strict control of rental periods. In order to promote online transactions further, the development of techniques for strict control of the rental periods has been sought.

The present invention has been made in consideration of the above. The present invention relates to a server for file distribution and to a file distribution system therewith. The server and the system make it possible to effectively restrict the use of files to a certain period of time.

A first aspect of the present invention, for attaining the above purpose is: a server for file distribution connected to a user terminal through a communication network. The first embodiment further includes a file data memory having digital file data to be transmitted; a program memory having a computer program managing and playing back the digital file data; a management/playback program stored in the program memory requested from said user terminal; and a transfer processing unit transferring said digital file data stored in the file data memory; wherein said transfer processing unit transfers digital file data requested from the user terminal, to which data on the date at which playback can be started and has to be finished are added, to the user terminal; and wherein said management/playback program performs a step of playing back the digital file data, which were started on the user terminal and transferred from it, a step of reading time data of the user terminal and checking if the time data indicate the range of time at which playback can be started and by when it has to be finished, a step of deleting said digital file data stored in the user terminal in case the read time data do not indicate the range of time at which playback can be started and by when it has to be finished, a step of enabling to play back said digital file data in case the read time data indicate the range of time at which playback can be started and by when it has to be finished, and a step of rewriting said time at which playback can be started by the read time data.

According to this file distribution server, if a user terminal accesses the file distribution server via a communication network, and then the server receives requests for distribution of digital files, the file distribution server adds data on the date at which playback can be started and by when it has to be finished to requested digital file data, and transfers them together with the management/playback program stored in the program memory to the user terminal that accessed the server. Referring to the date at which playback can be started and by when it has to be finished, it can be calculated either by pre-determined rental periods, or by a user.

During the permissible period, digital file data and the management/playback program are transferred to the user terminal, they are stored in the user terminal, and then the management/playback program is suitably set up on the user terminal, and is ready to be started. Additionally, when the management/playback program has already been transferred and stored in the user terminal, one may transfer the digital file data, which is requested to be distributed to the user terminal, alone.

Next, when the management/playback program is started on the user terminal, the management/playback program performs the following steps:

a step of adding the management/playback program to digital file data, reading out data on the date at which playback can be started and by when it has to be finished being stored in the user terminal, reading time data real time with the clock function stored in the user terminal, and checking if read time data indicate the range of dates at which playback can be started and by when it has to be finished. These steps can be performed either regarding all the digital file data stored in the user terminal or regarding digital file data alone which were selected by users for playback.

Thereafter, when the read date indicates the range of dates at which playback can be started and by when it has to be finished, the digital file data can be played back, and if playback is chosen, the digital file data will be played back. On the other hand, if the read time does not indicate the range of time at which playback can be started and when it has to be finished, the digital file data stored in the user terminal are deleted.

In addition, said management/playback program performs a step of rewriting the date at which playback can be started and by when it has to be finished with the read data as well as the performance of the above.

Typically, a user can freely change the time that is calculated and displayed in the clock function stored in a user terminal. So, even if the real date and time have passed the time at which playback has to be finished, a user can play back the digital file data by changing the time calculated and displayed in the said clock function into a date that falls between the date at which playback can be started and the one by which it has to be finished. However, if this state is left as it is in which such unauthorized performance can be done, it becomes possible to play back the digital file data outside of the authorized rental periods, and thus, the right of a copyright holder could be infringed.

Therefore, in the present invention, the date at which playback can be started is supposed to be rewritten by the time data read from the user terminal after the management/playback program is started. By taking this action, the date at which playback can be started is rewritten whenever a user starts the management/playback program, which steadily approaches the date by which playback has to be finished, thus, a user will be unable to play back even if he changes the clock time on his own user terminal.

In this way, with the file distribution server related to the present invention, restrictions may be placed on the playback of distributed digital files. Therefore, this fact makes it possible to certainly prevent the right of copyright holders concerning the digital file from blatant infringement.

In a further aspect out of the present invention, the management/playback program 1 performs a step of calculating a lapse after reading the time, a step of calculating real time by adding a lapse calculated in the above step to the read time, a step of updating date at which playback can be started with the real time calculated in the above step.

According to this file distribution server, a lapse after reading time is calculated with said management/playback program which is transferred from the data distribution server and started on the user terminal, real time is calculated by adding the calculated lapse to the read time, and the date at which playback can be started is updated with calculated real time.

Thus, whenever a user starts the management/playback program, the date at which playback can be started steadily approaches to the date by which playback has to be finished by the read lapse, said playback permitted periods which are specified by the date at which playback can be started and the one by which playback has to be finished are narrowed. This fact makes it possible to severely reduce the opportunity for a user to play back a digital file by dishonestly changing the clock time on his own user terminal.

In a still further aspect, the management/playback program performs a step of calculating a lapse after reading the time, a step of calculating real time by adding a lapse calculated in the step to the read time, a step of checking if the real time calculated in the above step indicates the range of dates at which playback can be started added to digital file data, and the date by which it has to be finished, a step of deleting the digital file data stored in the user terminal when the calculated real time does not indicate the range of dates at which playback can be started and by when it has to be finished, and a step of enabling to play back the digital file data in the case said calculated real time indicates the range of date at which playback can be started and by when it has to be finished.

According to this file distribution server, a lapse after the read time is calculated with the management/playback program started on said user terminal, the real time is calculated by adding said lapse to the read time, and it is checked to determine if the calculated real time indicates a date within the range of dates at which playback can be started and by when it has to be finished. If the real time does not indicate the range of dates at which playback can be started and by when it has to be finished, the digital file data stored in said user terminal is deleted. However, if calculated real time indicates the range of dates at which playback can be started and by when it has to be finished, the digital file data can be played back. These steps can be performed either with all the digital file data stored in the user terminal or with digital file data alone which were selected by users for playback.

Thus, according to this file distribution server, management of rental periods can be done more strictly because whether rental periods have expired or not is determined from a lapse after the management/playback program is started. And, it is possible to prevent unauthorized prolongation of rental periods by dishonest time manipulation by a user because the end of rental periods is determined based on a lapse which the management/playback program calculates.

In a still further aspect of the present invention, the management/playback program further performs a step of reading time data real time of its start on the user terminal from the user terminal, a step of calculating lapses after it is started on the user terminal successively, a step of calculating real time by adding the calculated lapses to the read time data of the moment of its start, and a step of reading time data of the moment of the time calculation and checking if the read time data and said calculated time data are located within a range of permissible error.

According to this server for file distribution, said management/playback program reads time data of the moment of its start from said user terminal, lapses after its start are calculated successively, the current time is calculated by adding those lapses to the read time data, time data when this time calculation is read from the user terminal, and it is checked to determine if the read time data and said calculated time data are located within a range of permissible error of each other.

Thus, time manipulation by a user can be detected immediately, if it is done when the management/playback program starts. If such time manipulation is detected, to stop playback, can prevent unauthorized prolongation of rental periods.

Moreover, a file distribution system, which includes any of the servers of the various aspects and user terminals that are connected to each other via communication network, becomes a system that can effectively prevent unauthorized use of digital files.

Furthermore, the deletion of the digital file data can be performed by overwriting digital file data entirely or partly by other data.

Note that the term digital file in this invention corresponds to digital information and data, such as characters, voices, and images, and computer programs. It includes digital music, movies, and novels, and also includes software games.

In addition, the term playback corresponds to the following: (1) outputting music sounds to the speakers of user terminals designed for digital music, (2) showing movies on the displays of user terminals designed for digital movies, (3) showing novels on the displays designed for digital novels, (4) making software games available on the user terminals designed for software games. Moreover, when reproduction is that the text of the novel concerned etc. is displayed on the above-mentioned display, when digitizing is that a movie projects on the display of the user terminal equipment, when digitizing is that the sound of the music concerned is output to the speaker of the user terminal equipment, when digitizing music, a movie, or a novel, etc., and game software, it means changing the game software concerned into the state which can be used on the user terminal equipment.

### BRIEF DESCRIPTION OF THE DRAWINGS

FIG. 1 is a block diagram showing the general structure of the file distribution system of an aspect of the present invention.

FIG. 2 is a block diagram showing the general structure of the file distribution server of an aspect of the present invention.

FIG. 3 is a flow chart to demonstrate the registration process at the user-registration module of the present invention.

FIG. 4 is a diagram to illustrate the divide-and-spread process of the digital file data of the present invention.

FIG. 5 is a flow chart to illustrate the distribution process at the transferring module of the present invention.

FIG. 6 is a flow chart to show the playback process of the present invention.

FIG. 7 is a flow chart to show the playback process of the present invention.

FIG. 8 is a flow chart to show the playback process of the present invention.

FIG. 9 is a flow chart to show the playback process module of the present invention.

### DETAILED DESCRIPTION OF THE PREFERRED EMBODIMENT

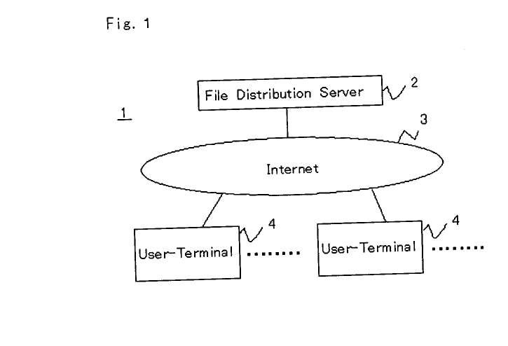

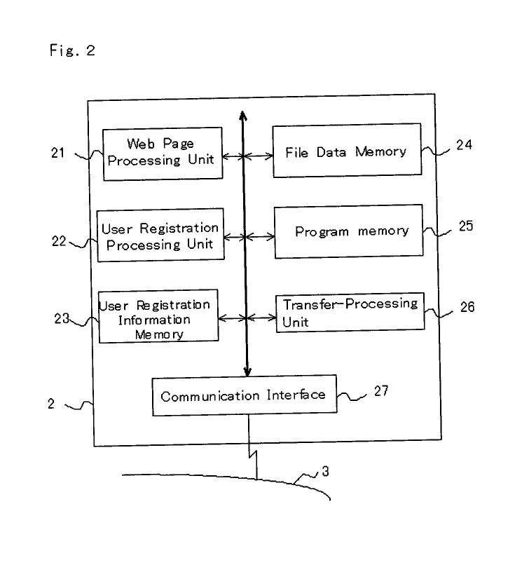

Details of one way of implementation for the present invention will be described below using the attached figures. FIG. 1 and FIG. 2 are block diagrams showing the general structures of the file distribution system and the file distribution server for the present invention respectively.

As shown in FIG. 1, the file distribution system 1 of this particular embodiment includes of a file distribution server 2 and multiple user terminals 4, all of which are connected via the Internet 3. The file distribution server 2 functions as a server with CGI script and the Internet servers such as WWW servers. Each of the user terminals 4 functions as a client with browsers.

The file distribution server 2 is a computer with a CPU, ROM, RAM, and the hard discs. As shown in FIG. 2, it has some function components such as a web page processing unit 21, a user-registration processing unit 22, a user-registration information memory 23, a contents data memory 24, a program memory 25, a transfer-processing unit 26, and a communication interface 27. The server is connected to the Internet 3 with the communication interface 27.

The web page processing unit 21 is a processing unit which opens up home pages on the Internet 3 for file distribution. Through these home pages, several processes are carried out such as user registration, transfer of the management/playback program, and distribution of digital files.

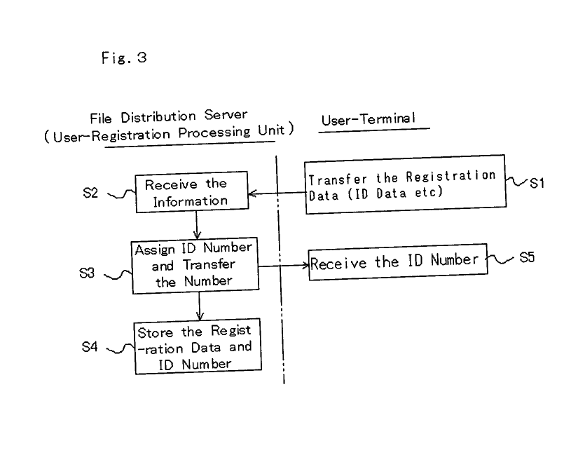

The user-registration processing unit 22 registers system-user information inputted from the user terminals 4 with the home pages. In detail, as shown in FIG. 3, when a user's registration information such as name, address, credit card number, e-mail address, password, etc, is input through the user terminal 4 (step S1), the user-registration processing unit 22 receives the information (step S2). Then the unit assigns an ID number to the user, and transfers it to the user terminal 4 (step S3). Each of the received user information and the assigned ID numbers are then stored in the user-registration information memory 23 (step S4). The screen of the user terminal 4 displays the transferred ID number (step S5), so that the user can see the number, and perhaps write down the number for future reference.

The contents data memory 24 stores various digital file data such as information data including characters, voices, and images (such as novels, essays, music, movies, pictures, paintings, designs, etc), and computer programs (such as software games).

The program memory 25 stores a management/playback program and a cipher key, which are transferred to the user terminal 4, and are run or used by the terminal. The details of the management/playback program will be described hereinafter.

The transfer-processing unit 26 transfers the management/playback program and the cipher key, which are stored in the program memory 25, in response to the request from the user terminal 4. The unit also loads requested digital file data from the file data memory 24, and after adding data on the dates at which playback can be started and has to be finished (the period between those dates is the authorized rental period) and encrypting with the cipher key, the unit transfers them to the user terminal 4.

The management/playback program is started on the user terminal 4 and carries out the following six processes: (1) making the storage space in the memory of user terminal 4 for digital file data to be transferred from the transfer-processing unit 26, (2) storing the transferred digital file data and data on the dates at which playback can be started and has to be finished into the storage space made in the previous process, after converting them into a divided-and-spread data group according to a rule set in advance, (3) re-storing the converted file data to original digital file data, by re-converting the converted data stored in the memory according to the set rule, (4) decrypting the restored digital file data, (5) playing back the deciphered digital file data on the user terminal 4, and (6) checking if the rental periods have expired, and if they have expired, the program deletes the converted file data stored in the memory.

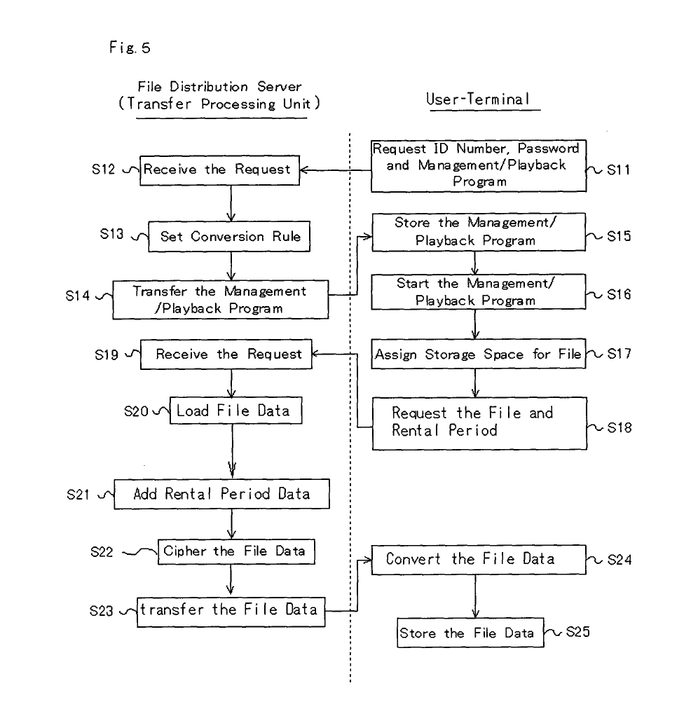

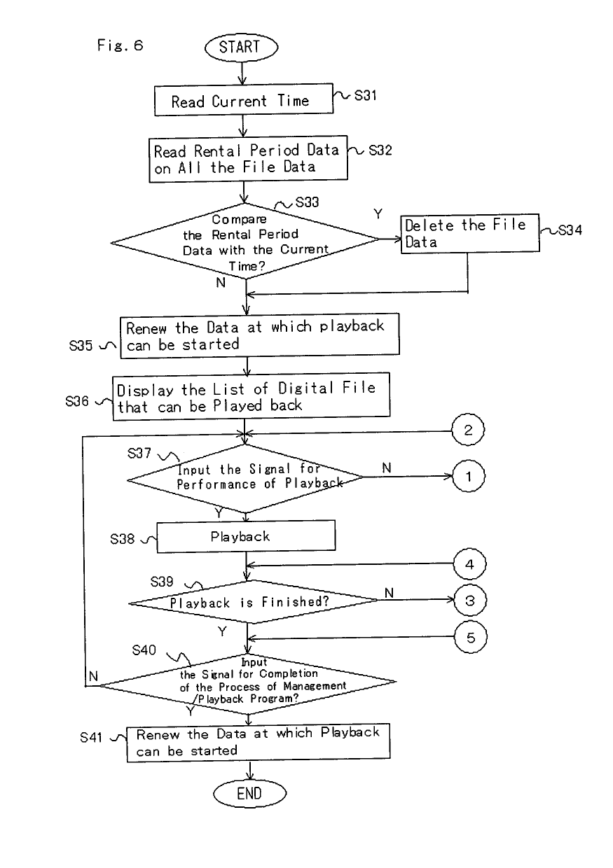

More details of the transfer-processing unit 26 and the management/playback program process will be explained below, using FIG. 5 and FIG. 6.

First, the distribution process of the files is described based on FIG. 5. As shown in FIG. 5, when a user terminal 4 inputs a request for transfer of user information such as an ID number and a password or that of a management/playback program via web pages (step S11), the transfer-processing unit 26 receives the request (step S12). Then, the transfer-processing unit 26 loads the requested management/playback program and a cipher key from the program memory 25, and sets a conversion rule for the divide-and-spread process of the digital contents. The conversion rule is unique to each one of its users' files (step S13). The set conversion rule data is transferred together with the management/playback program and the cipher key to the requesting user terminal 4 (step S14), and then they are stored in the user terminal 4 (step S15).

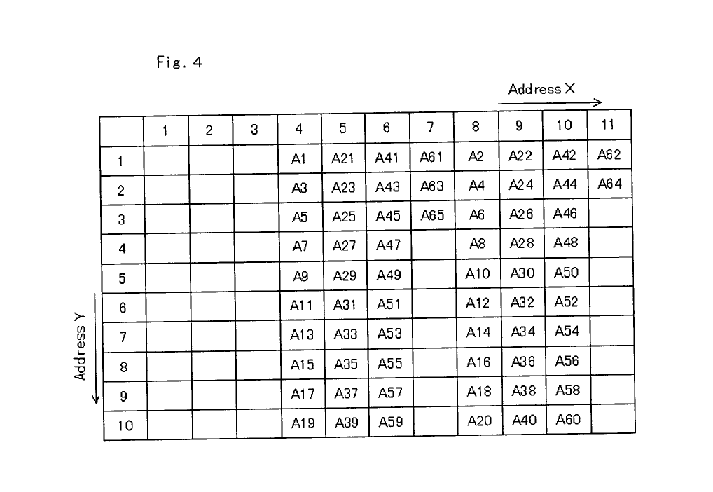

Next, when the transferred management/playback program is started on the user terminal 4 (step 516), this management/playback program makes storage space in the memory of the user terminal 4 for storing digital file data to be transferred from the file distribution server 2 (step S17). Specifically, as shown schematically in FIG. 4, the program sets two-dimensional storage space with addresses in vertical (Y) and horizontal (X) dimensions. The size of the storage space is adjusted according to the amount of data to be stored in the space.

After the setting of the storage space, the management/playback program enables the user terminal 4 to request a file from the file distribution server 2 (step S18). In other words, the program opens communication between the file distribution server 2 and the user terminal 4, and displays a file list, which is stored in the file data memory 24 of the file distribution server 2, on the screen of the user terminal 4. Then, the program makes it possible for user to select files from the displayed list, or to enter the rental periods.

Then, after the necessary information (file to rent, rental period, etc.) is fixed on the user terminal 4 (step S18), it is transferred to the file distribution server 2, and received by the transfer-processing unit 26 (step S19).

By receiving the input from the user terminal 4, the transfer-processing unit 26 loads requested digital file data from the file data memory 24 (step S20). Then, the transfer-processing unit 26 adds the data on dates at which the playback can be started and has to be finished (those are set based on said rental periods) to the loaded digital file data (step S21), and after encrypting the data, transfers them to the user terminal 4 (step S23). Now, considering the playback process that will be done later, data on said dates at which playback can be started and has to be finished (henceforth “rental period data”) is desirable to be a fixed-size data and to be inserted in the head of the digital file data. Thus, the present invention adopted this procedure.

After receiving the encrypted digital file data and the rental period data that are added to it, the management/playback program, run on the user terminal 4, converts the received data into the divided-and-spread data group according to the conversion rule (file data conversion, step S24). Then, the program stores the data into the storage space so as to make the data partly or completely discontinuous (step S25).

The specific way of the divide-and-spread process is as the following. First, the received data is sequentially divided into segments with a predetermined size. Then, the divided data is stored in the memory with the address calculated by the formula,

X=P×á+â

where P is a constant assigned for and unique to each user, á is an integer that has the value form 1 to n, and â is an integer with the value from 0 to m. Also, n depends on the horizontal size of the storage space, and m depends on P. In this case, the conversion rule is the formula, and the term “conversion to divided-and-spread data group” corresponds to the action of storing the digital file data into the storage space after dividing and spreading.

More specifically, the management/playback program sets the address of Y=1 and the value of á=0, and then it changes á sequentially from 1 to n. Using these values, the program calculated address X with the formula shown above, and stores divided data in the storage space corresponding to the calculated address (X, Y=1). Afterwards, changing the address Y from 2 to a fixed maximum value, and setting â=0 and changing á from 1 to n, the program calculates address X by changing â from 1 to m sequentially and iterating the same process. And then the program stores divided data sequentially in the derived address (X, Y).

FIG. 4 shows the way of storing the divided file data (A1-A65) in the address calculated above, by setting the maximum value of address X=11, that of address Y=10, P=4, á=1 to 2, and â=0 to 3. The divided file data is not stored in the space of address X=1 to 3.

In this way, the term “partly discontinuous” is defined as the state in which there are other data between the divided file data stored in the X-directional, if the direction of data reading is the X-direction. Similarly, the term “completely discontinuous” is defined as the state in which other data are stored in all the spaces between each of the reading-directionally divided file data. The term “other data” in above definitions corresponds to other file data or any data other than file data. Regarding the case shown above, the divided file data would be completely discontinuous if â is set taking only odd or even numbers. In this way, digital file data and rental period data attached to it is distributed from the file distribution server 2 to the user terminal 4, and then the data is stored in the user terminal.

The process of playing back the digital file that is stored in the user terminal 4 is described below, based on FIGS. 6 to 8.

When the management/playback program is started in playback mode, as shown in FIG. 6, the program reads the current time from a clock function in the user terminal 4 (step S31), and then it loads each of rental period data on all the digital file data respectively (step S32). Each of the rental period data is inserted at the head of digital file data, and stored in the memory together with the file data after the divide-and-spread process. Therefore, the process of loading the rental period data starts with calculating the address X, Y in which the rental period data is stored. The address is calculated according to the conversion rule (the above formula). Then the data is decrypted with the cipher key, which is transferred from the server 2 together with the management/playback program and stored in the user terminal 4.

Next, the read current time and the loaded rental period data are compared (step S33). If there is current time that passes over the rental period, i.e., if there is current time that is not located between dates at which playback can be started and by when it has to be finished, the process proceeds, after performing a deletion of the digital file data (step S34), to step S35. On the other hand, if there is no current time that falls within the rental period, i.e., if every current time is located between dates at which playback can be started and by when it has to be finished, the process proceeds to step S35 immediately.

In said step S35, renewal of the date at which playback can be started is performed by the read current time data. After this performance, a list of digital file that can be played back is displayed on said user terminal 4 (step S36).

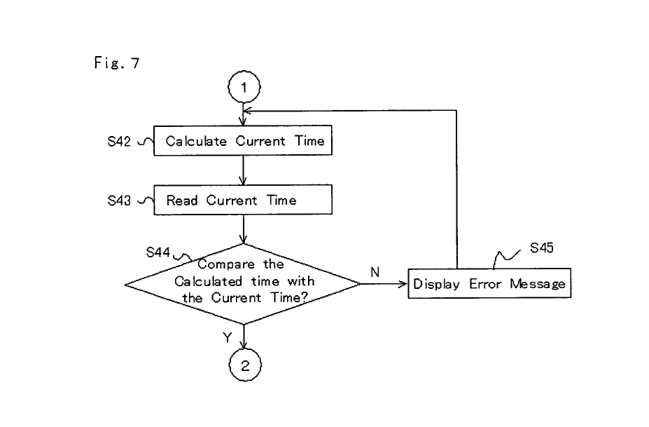

Next, digital file to be played back is selected from displayed list, and when the signal for performance of playback is input, playback of step S38 is performed. Conversely, if the signal for performance of playback is not input, the process of step S42 to S45 shown in FIG. 7 is carried out repeatedly until it is input (step S37).

That is, in step S42, the lapse after the management/playback program is started is read, and current time is calculated by adding the lapse to the read time from said user terminal 4 after it is started. In addition, lapse can be calculated based on a clock stored inside of the CPU of the user terminal 4 etc., and it is calculated one after another after the management/playback program is started, in parallel to the steps shown in FIG. 6.

Therefore, after the current time is calculated, the current time is read from the clock function stored inside of the user terminal 4 (step S43), to determine whether read current time and calculated current time are located within a range of permissible error or not (step S44), and if they are not located within a range of permissible error, the error is displayed on said user terminal 4 until the clock function stored inside of the user terminal 4 is corrected (step S45).

Moreover, the playback includes three processes: (1) loading of the digital file data that is stored in the memory after dividing and spreading, (2) decrypting the loaded digital file, and (3) playing back the decrypted digital file data. These processes can be carried out either in serial/parallel, or entirely in serial.

The loading process of the digital file data is done in the same way as the loading process of the rental period data. That is, the addresses X and Y are calculated sequentially according to the conversion rule (the above formula), and the data stored in the address are loaded sequentially. The decrypting process is done similarly based upon the cipher key, which is transferred with the management/playback program and stored in the user terminal 4.

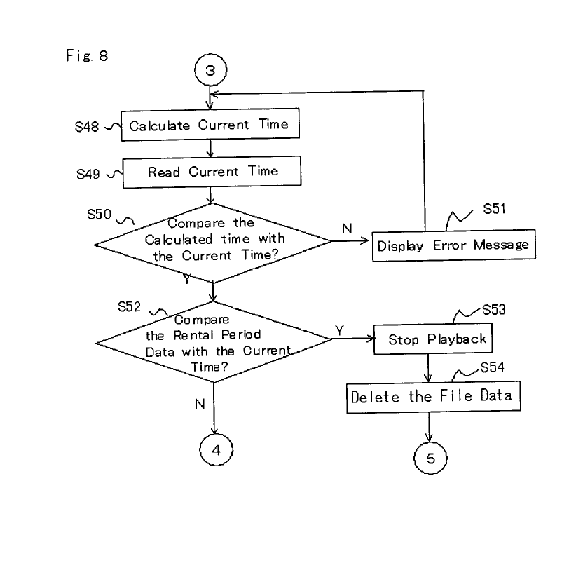

While this playback process is completed, the performance of steps S48 to S54 shown in the FIG. 8 is carried out repeatedly (step S39).

That is, in step S48, in the same way as in step S42, the lapse after the management/playback program is started is read, and the current time is calculated by adding the lapse to the time which it is loaded from said user terminal 4 after it is started. After calculating current time in the above way, the real time is read from the clock function stored inside of the user terminal 4 (step S49), whether read current time and calculated current time are located within a range of permissible error is checked (step S50), and if they are not located within a range of permissible error, the error is displayed on said user terminal 4 until the clock function stored inside of the user terminal 4 is corrected (step S51).

In the above way, when it is confirmed that the read current time and calculated current time are located within a range of permissible error. Next, whether said calculated current time is between date at which playback can be started and by when it has to be finished is checked (step S52), and if it is not located between the date at which playback can be started and by when it has to be finished, the process of playback is stopped (step S53), then the digital file data is deleted (step S54).

When the process of playback is finished, the process of step S37 and later is repeated until completion of the process of the management/playback program is input (step S40). In the case that completion of the process is input, after the date at which playback can be started on the digital file data is changed with the current time data calculated in the step S48 (step S41), the series of process is completed.

The term playback corresponds to the following: (1) outputting the music sounds to the speakers of user terminal 4 designed for digital music, (2) showing the movies on the displays of user terminal 4 designed for digital movies, (3) showing the novels on the displays designed for digital novels, (4) making the software games available on the user terminal 4 designed for software games.

The deletion process is a process to overwrite a part or all of the digital file data with other data. The address X, Y of the digital file data is determined using the conversion rule (the above formula).

As described above, in the file distribution system 1 in this case, since the date at which playback can be started is supposed to be rewritten by time data read from the user terminal 4 after the management/playback program is started (step S35), the date at which playback can be started is rewritten whenever a user starts the management/playback program, and it approaches the date by which playback has to be finished. So, the playback permissible period specified by the date at which playback can be started and by when it has to be finished is narrowed certainly. Therefore, even if a user changes the clock time of his own terminal, the clock time immediately goes out of playback permissible period (between the date at which playback can be started and by when it has to be finished), thereby making playback impossible.

Moreover, since lapse after said management/playback program is started, current time is calculated by adding the lapse to time read at the moment of starting and the date at which playback can be started is renewed by the calculated current time (step S41), the date at which playback can be started certainly approaches to the date by which playback has to be finished, by a lapse after starting, whenever a user starts the management/playback program, and a playback permissible period specified by date at which playback can be started and by when it has to be finished is narrowed certainly. By this, the opportunity is reduced that a user plays back a digital file by changing the clock time of his own terminal.

Furthermore, since whether the rental period is over or not is determined with a lapse after starting the management/playback program (step S52), it is possible to manage the rental period more strictly and since the completion of the rental period is determined from a lapse that management/playback program calculates, one can prevent the unauthorized extension of the rental period by time manipulation by a user.

In addition, in this file distribution system 1, while time data at the moment of the start of the management/playback program is read from the user terminal 4, a lapse after starting is calculated one by one, and the time at the moment is calculated by adding a lapse to the read time data, time data at the moment of calculation of the time from user terminal 4, whether the read current time and the calculated current time are located within a range of permissible error is checked (step S42 to S44 and step S48 to S50), therefore in the case that unjust time manipulation is carried out by a user after the management/playback program is started, it can be detected immediately.

Moreover, requested digital file data are divided according to the rules (conversion rules) set uniquely to each user, and then stored in the user terminal 4 discontinuously spread. In addition, without the management/playback program that has a re-conversion function of digital files based on the rules uniquely set for each user, the distributed file cannot be played back. Therefore, even if transferred digital files (converted digital files) are copied, general playback programs cannot play back the copied files. In addition, because each management/playback program does not have compatibility with each other, users cannot play back digital file data that are distributed to other users. Furthermore, by converting file data into divided-and-spread data group, analyzing and restoring the data become highly difficult. Therefore, pirating of the transferred files becomes meaningless, and this fact makes it possible to prevent illegal usage of transferred files and piracy by illegal copying and distribution.

Although an example of the implementation for the present invention has been explained, specific ways of implementation that the present invention can carry out are not limited to the above description. For example, in the above description, whether rental period is over is checked on all the digital file data stored in user terminal 4 after said management/playback program is started. The implementation of the present invention, however, is not limited to the structure described above. The rental period can be checked only on digital files that are selected to be played back, after a list of all the digital file data stored in user terminal 4 is displayed first, after the starting.

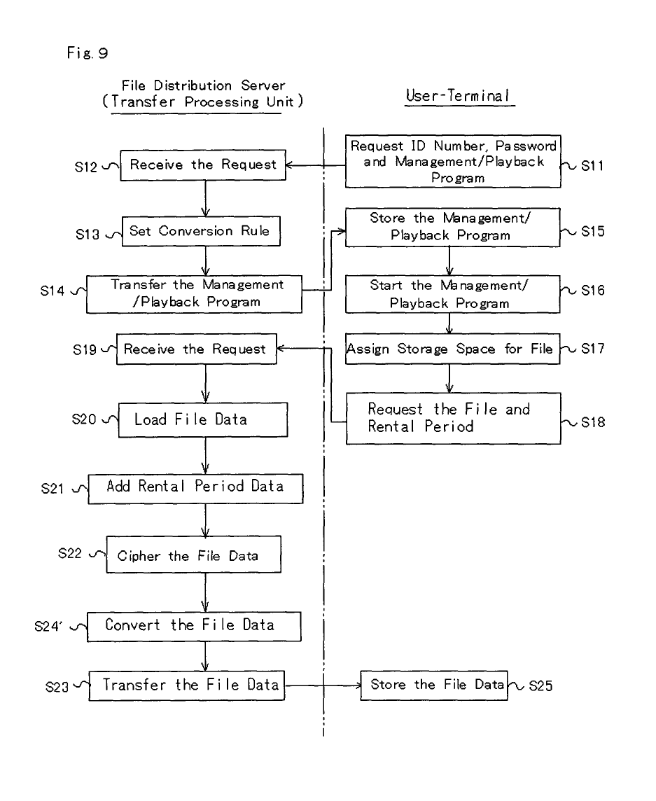

In the above description, the management/playback program that is run on the user terminal 4 divides and spreads (converts) the distributed digital file, and stores it in the memory of user terminal 4. The implementation of the present invention, however, is not limited to the structure described above. As shown in FIG. 9, the divide-and-spread process (contents data conversion) can be done in the transfer-processing unit 26 (step S24′). The procedure of the divide-and-spread process can be the same one as described above.

Although rental period data in the original explanation is divided-and-spread as well as digital file data, it is possible to convert only digital file data.

In addition, the conversion rule unique to each user is not limited to the formula shown above. For example, one with a random number is also effective.

In this way, with the file distribution server related to the present invention, restriction can certainly be placed on playback of distributed digital files. Therefore, this fact makes it possible to certainly prevent the right of copyright holders concerning the digital file from blatant infringement.

What is claimed is:

1. A server for file distribution connected to a user terminal through a communication network comprising:
a file data memory having digital file data to be transmitted;
a program memory having a computer program managing and playing back said digital file data;
a management/playback program stored in said program memory requested from said user terminal; and
a transfer processing unit transferring said digital file data stored in said file data memory;
wherein said transfer process unit transfers digital file data requested from said user terminal added by data on a date at which playback can be started and when it has to be finished to said user terminal;
wherein said management/playback program, which is started on a user terminal, performs a step of playing back said transferred digital files,
a step of reading time data of said user terminal after said start and checking if said read time is located between date at which playback can be started and when it has to be finished is added to digital file data,
a step of deleting said digital file data stored in said user terminal if said read time data is not between said date at which playback can be started and when it has to be finished,
a step of making it possible to play back said digital file data if said read time data is between said date at which playback can be started and when it has to be finished, and
a step of rewriting said date at which playback can be started by said read time data.

2. The server for file distribution connected to a user terminal through a communication network according to claim 1 wherein said management/playback program performs:
a step of calculating a lapse after reading said time,
a step of calculating current time by adding said calculated lapse to said read time, and
a step of renewing said date at which play back can be started by said calculated current time.

3. The server for file distribution connected to a user terminal through a communication network according to claim 1 or 2 wherein said management/playback program performs:
a step of calculating lapse after said time reading,
a step of calculating current time by adding said calculated lapse to said read time,
a step of checking if said calculated current time is between date at which playback can be started and when it has to be finished added to digital file data,
a step of deleting said digital file data stored in said user terminal if said calculated current time is not between said date at which playback can be started and when it has to be finished, and
a step of making it possible to play back said digital file data if said calculated current time is between said date at which playback can be started and when it has to be finished.

4. The server for file distribution connected to a user terminal through a communication network according to claim 1 wherein said management/playback program performs:
a step of reading time when it is started on said user terminal from the user terminal,
a step of calculating a lapse one by one after it is started on said user terminal,
a step of reading time data when said time calculation from the user terminal and checking if the read time data and said calculated time data are located within a range of permissible error.

5. The server for file distribution connected to a user terminal through a communication network according to claim 4 wherein said management/playback stops a playback process when said read time data and said calculated time data are not located within said range of permissible error.

6. A file distribution system comprising:
a server for file distribution;
a user terminal connected through a communication network;
wherein said server for file distribution is a server of claim 1.
